(19) United States
(12) Patent Application Publication
(10) Pub. No.: US 2015/0294485 A1
(43) Pub. Date: Oct. 15, 2015

(54) METHOD OF COMPENSATING AN IMAGE BASED ON LIGHT ADAPTATION, DISPLAY DEVICE EMPLOYING THE SAME, AND ELECTRONIC DEVICE

(71) Applicant: Samsung Display Co., Ltd., Yongin-City (KR)

(72) Inventors: Rang-Kyun Mok, Seoul (KR); Hak-Sun Kim, Seoul (KR); Won-Sang Park, Yongin-Si (KR); Jong-In Baek, Suwon-Si (KR)

(21) Appl. No.: 14/535,089

(22) Filed: Nov. 6, 2014

(30) Foreign Application Priority Data
Apr. 15, 2014 (KR) 10-2014-0044599

(51) Int. Cl. G06T 11/00

(52) U.S. Cl. CPC G06T 11/001

(57) ABSTRACT

A method of compensating an image based on light adaptation, a display device employing the same and an electronic device are disclosed. In one aspect, the method includes determining a degree of light adaptation based on an amount of long-wavelength light in an illumination environment where the image is displayed, converting image data in International Commission on Illumination (CIE) red-green-blue (RGB) color space to image data in CIE long-medium-short (LMS) color space for implementing the image via CIE-XYZ color space, applying the degree of light adaptation to the converted image data in the CIE-LMS color space so as to generate compensated image data, and converting the compensated image data in the CIE-LMS color space to image data to be displayed in the CIE-RGB color space via the CIE-XYZ color space.

### CROSS-REFERENCE TO RELATED APPLICATION(S)

This application claims priority under 35 USC §119 to Korean Patent Application No. 10-2014-0044599, filed on Apr. 15, 2014 in the Korean Intellectual Property Office (KIPO), the contents of which are incorporated herein in its entirety by reference.

### BACKGROUND

1. Field

The described technology generally relates to a method of compensating an image based on light adaptation, a display device employing the same, and an electronic device.

2. Description of the Related Technology

Recently, as usage of electronic device (e.g., a television, a smartphone, a tablet, etc.) increases, much research is being conducted related to the effect of the electronic device (i.e., a display device included in the electronic device) on users when the device has been continuously used for a certain amount of time. Generally, serotonin is produced (or, secreted) inside a human body in daytime, and melatonin is produced (or, secreted) inside the body at night. That is, the production of melatonin induces sleep.

A short-wavelength light (e.g., a blue color light having a center wavelength of 464 nm) suppresses melatonin from being produced inside the body. Thus, when a user uses an electronic device for a long time at night, production of melatonin can be suppressed inside the body. This can have a negative effect on the biological clock (e.g., sleeping disorders). This happens because the brain misrecognizes the short-wavelength light output from the image displayed by the electronic device as daytime (i.e., the short-wavelength light has a color that is similar to the color most seen in daylight).

### SUMMARY OF THE CERTAIN INVENTIVE ASPECTS

One inventive aspect is a method of compensating an image based on light adaptation capable of minimizing suppression of production of “melatonin” inside human body of a user due to a short-wavelength light while the user does not notice compensation of an image that is displayed by a display device.

Another aspect is a display device employing the method of compensating an image based on light adaptation.

Another aspect is an electronic device (e.g., a smartphone, a smart pad, etc) including the display device.

Another aspect is a method of compensating an image based on light adaptation that can include an operation of determining a degree of light adaptation due to a long-wavelength light by analyzing an illumination environment where a user views an image displayed by a display device, an operation of converting image data for implementing the image from CIE-RGB color space to CIE-LMS color space via CIE-XYZ color space, an operation of generating compensated image data by applying the degree of light adaptation to converted image data in the CIE-LMS color space, and an operation of converting the compensated image data from the CIE-LMS color space to the CIE-RGB color space via the CIE-XYZ color space.

In example embodiments, the image data can be compensated when the degree of light adaptation is greater than a predetermined reference value.

In example embodiments, when a difference between a degree of current light adaptation due to the long-wavelength light and a degree of previous light adaptation due to the long-wavelength light is smaller than a predetermined comparison value, the degree of previous light adaptation can be applied to the converted image data in the CIE-LMS color space.

In example embodiments, the image data can be compensated to decrease luminance of a short-wavelength light output from the image as the degree of light adaptation increases.

In example embodiments, production of melatonin can increase inside human body of the user as the luminance of the short-wavelength light decreases.

In example embodiments, when the display device is an organic light-emitting display device, a life of the display device can increase as the luminance of the short-wavelength light decreases.

In example embodiments, the short-wavelength light can include a blue color light, and the long-wavelength light can include a red color light and a green color light.

Another aspect is a display device that can include a display panel including a plurality of pixels, a scan driving unit configured to provide a scan signal to the display panel, a data driving unit configured to provide a data signal to the display panel, a compensation unit configured to compensate image data corresponding to the data signal based on a degree of light adaptation due to a long-wavelength light to decrease luminance of a short-wavelength light output from an image that is displayed on the display panel, and a timing control unit configured to control the scan driving unit, the data driving unit, and the compensation unit.

In example embodiments, the compensation unit can be external to the timing control unit and the data driving unit.

In example embodiments, the compensation unit can be included in the timing control unit or in the data driving unit.

In example embodiments, the display device can be an organic light-emitting display device that includes a power unit configured to provide a high power voltage and a low power voltage to the display panel.

In example embodiments, the display device can be a liquid crystal display device that includes a backlight unit configured to provide light to the display panel.

In example embodiments, the compensation unit can include an analysis block configured to determine the degree of light adaptation by analyzing an illumination environment where a user views the image, a conversion block configured to convert the image data from CIE-RGB color space to CIE-LMS color space via CIE-XYZ color space, a compensation block configured to generate compensated image data by applying the degree of light adaptation to converted image data in the CIE-LMS color space, and a reverse conversion block configured to convert the compensated image data from the CIE-LMS color space to the CIE-RGB color space via the CIE-XYZ color space.

In example embodiments, the compensation unit can compensate the image data when the degree of light adaptation is greater than a predetermined reference value.

In example embodiments, when a difference between a degree of current light adaptation due to the long-wavelength light and a degree of previous light adaptation due to the long-wavelength light is smaller than a predetermined comparison value, the compensation unit can apply the degree of previous light adaptation to the converted image data in the CIE-LMS color space.

In example embodiments, the compensation unit can compensate the image data to decrease the luminance of the short-wavelength light output from the image as the degree of light adaptation increases.

In example embodiments, the short-wavelength light can include a blue color light, and the long-wavelength light can include a red color light and a green color light.

Another aspect is an electronic device that can include a display device, a memory device, and a processor configured to control the display device and the memory device. Here, the display device can include a display panel including a plurality of pixels, a scan driving unit configured to provide a scan signal to the display panel, a data driving unit configured to provide a data signal to the display panel, a compensation unit configured to compensate image data corresponding to the data signal based on a degree of light adaptation due to a long-wavelength light to decrease luminance of a short-wavelength light output from an image that is displayed on the display panel, and a timing control unit configured to control the scan driving unit, the data driving unit, and the compensation unit.

In example embodiments, the compensation unit can include an analysis block configured to determine the degree of light adaptation by analyzing an illumination environment where a user views the image, a conversion block configured to convert the image data from CIE-RGB color space to CIE-LMS color space via CIE-XYZ color space, a compensation block configured to generate compensated image data by applying the degree of light adaptation to converted image data in the CIE-LMS color space, and a reverse conversion block configured to convert the compensated image data from the CIE-LMS color space to the CIE-RGB color space via the CIE-XYZ color space.

In example embodiments, the degree of light adaptation can be determined when a user touches or drags a graphic displayed on the display panel based on a graphic user interface.

Another aspect is a method of compensating an image to be displayed by a display device based on light adaptation, the method comprising determining a degree of light adaptation based on an amount of long-wavelength light in an illumination environment where the image is displayed, converting image data in International Commission on Illumination (CIE) red-green-blue (RGB) color space to image data in CIE long-medium-short (LMS) color space for implementing the image via CIE-XYZ color space, applying the degree of light adaptation to the converted image data in the CIE-LMS color space so as to generate compensated image data, and converting the compensated image data in the CIE-LMS color space to image data to be displayed in the CIE-RGB color space via the CIE-XYZ color space.

In the above method, the applying is performed when the degree of light adaptation is greater than a predetermined reference value. In the above method, when the difference between degrees of the current light adaptation and the previous light adaptation based on the amount of long-wavelength light in the environment is less than a predetermined comparison value, the degree of the previous light adaptation is applied to the converted image data.

In the above method, the luminance of a short-wavelength light output from the image decreases as the degree of light adaptation increases.

In the above method, production of melatonin increases inside the body of the user as the luminance of the short-wavelength light decreases.

In the above method, when the display device is an organic light-emitting diode (OLED) display, the lifespan of the display device increases as the luminance of the short-wavelength light decreases.

In the above method, the short-wavelength light includes blue color light, wherein the long-wavelength light includes red color light and green color light.

Another aspect is a display device comprising a display panel including a plurality of pixels, a scan driver configured to provide at least one scan signal to the display panel, a data driver configured to provide at least one data signal to the display panel, a compensation unit configured to decrease luminance of a short-wavelength light output from an image displayed on the display panel based on image data corresponding to the data signal and a degree of light adaptation based on an amount of long-wavelength light in the environment, and a timing controller configured to control the scan driver, the data driver, and the compensation unit.

In the above display device, the compensation unit is located outside the timing controller and the data driver.

In the above display device, the timing controller or the data driver includes the compensation unit.

The above display device further comprises a power unit configured to provide high and low power voltages to the display panel, wherein the display device is an organic light-emitting diode (OLED) display.

The above display device further comprises a backlight unit configured to provide light to the display panel, wherein the display device is a liquid crystal display (LCD).

In the above display device, the compensation unit includes an analysis block configured to determine the degree of light adaptation in an illumination environment where a user views the image, a conversion block configured to convert the image data in International Commission on Illumination (CIE) red-green-blue (RGB) color space to converted image data in CIE long-medium-short (LMS) color space via CIE-XYZ color space, a compensation block configured to apply the degree of light adaptation to the converted image data so as to generate compensated image data, and a reverse conversion block configured to convert the compensated image data in the CIE-LMS color space to displayed image data in the CIE-RGB color space via the CIE-XYZ color space.

In the above display device, the compensation unit is configured to generate the displayed image data when the degree of light adaptation is greater than a predetermined reference value.

In the above display device, when the difference between degrees of the current light adaptation and the previous light adaptation based on the long-wavelength light in the environment is less than a predetermined comparison value, the compensation unit is configured to apply the degree of the previous light adaptation to the converted image data.

In the above display device, the compensation unit is configured to decrease the luminance of the short-wavelength light output from the image when the degree of light adaptation increases.

In the above display device, the short-wavelength light includes blue color light, wherein the long-wavelength light includes red color light and green color light.

Another aspect is an electronic device comprising a display device, a memory device electrically connected to the display device, and a processor configured to control the display device and the memory device. The display device includes a display panel including a plurality of pixels, a data driver configured to provide at least one data signal to the display panel, and a compensation unit configured to decrease luminance of a short-wavelength light output from an image displayed on the display panel based on image data corresponding to the data signal and a degree of light adaptation based on an amount of long-wavelength light in the environment.

In the above electronic device, the compensation unit includes an analysis block configured to determine the degree of light adaptation in an illumination environment where the image is displayed, a conversion block configured to convert the image data in International Commission on Illumination (CIE) red-green-blue (RGB) color space to converted image data in CIE long-medium-short (LMS) color space via CIE-XYZ color space, a compensation block configured to apply the degree of light adaptation to the converted image data so as to generate compensated image data, and a reverse conversion block configured to convert the compensated image data in the CIE-LMS color space to displayed image data in the CIE-RGB color space via the CIE-XYZ color space.

In the above electronic device, the degree of light adaptation corresponds to touching or dragging a graphic displayed on the display panel based on a graphical user interface.

According to at least one embodiment, a method of compensating an image based on light adaptation can compensate image data based on a degree of light adaptation due to a long-wavelength light to decrease luminance of a short-wavelength light output from an image that is displayed by a display device. Thus, the method can minimize (or, reduce) suppression of production of “melatonin” inside human body of the user while the user does not notice compensation of the image that is displayed by the display device. As a result, a bad effect on biological clock of the user (e.g., sleeping disorders) can be reduced when the user views the image that is displayed by the display device.

In addition, a display device employing the method of compensating an image based on light adaptation according to example embodiments can minimize (or, reduce) suppression of production of “melatonin” inside human body of a user while the user does not notice compensation of an image that is displayed by the display device. As a result, a bad effect on biological clock of the user (e.g., sleeping disorders) can be reduced when the user views the image that is displayed by the display device. Moreover, unnecessary power consumption and pixel degradation can be prevented (or, reduced) when the display device is an organic light-emitting display device.

Further, an electronic device including the display device according to example embodiments can reduce a bad effect on biological clock of a user (e.g., sleeping disorders) when the user views an image that is displayed by the display device.

### BRIEF DESCRIPTION OF THE DRAWINGS

FIG. 1 is a flowchart illustrating a method of compensating an image based on light adaptation according to example embodiments.

FIG. 2 is a diagram illustrating a process in which image data is compensated by the method of FIG. 1.

FIG. 3 is a graph illustrating a change of visibility curves according to an illumination environment with reference to the method of FIG. 1.

FIG. 4 is a diagram illustrating an example in which a degree of light adaptation due to a long-wavelength light is applied to converted image data by the method of FIG. 1.

FIG. 5 is a diagram illustrating an effect of image data that are compensated by the method of FIG. 1.

FIG. 6 is a block diagram illustrating a display device according to example embodiments.

FIG. 7 is a block diagram illustrating an example of a compensation unit included in the display device of FIG. 6.

FIG. 8 is a block diagram illustrating a display device according to example embodiments.

FIG. 9 is a block diagram illustrating an electronic device according to example embodiments.

FIG. 10 is a diagram illustrating an example in which the electronic device of FIG. 9 is a smartphone.

FIG. 11 is a flowchart illustrating a process in which image compensation based on light adaptation is performed by the electronic device of FIG. 9.

FIG. 12 is a diagram illustrating an example of a light source included in the electronic device of FIG. 9 for performing image compensation based on light adaptation.

FIG. 13 is a diagram illustrating another example of a light source included in the electronic device of FIG. 9 for performing image compensation based on light adaptation.

FIG. 14 is a flowchart illustrating a process in which a degree of light adaptation due to a long-wavelength light is determined in the electronic device of FIG. 9.

FIG. 15 is a diagram illustrating an example in which a user determines a degree of light adaptation due to a long-wavelength light in the electronic device of FIG. 9.

FIG. 16 is a diagram illustrating another example in which a user determines a degree of light adaptation due to a long-wavelength light in the electronic device of FIG. 9.

### DETAILED DESCRIPTION OF THE PREFERRED EMBODIMENT

Viewing images on an electronic device during the evening can be disruptive to our biological clock and can cause sleeping disorders. Therefore, minimizing the above negative effect on the biological clock is desirable.

Hereinafter, embodiments of the described technology will be explained in detail with reference to the accompanying drawings. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

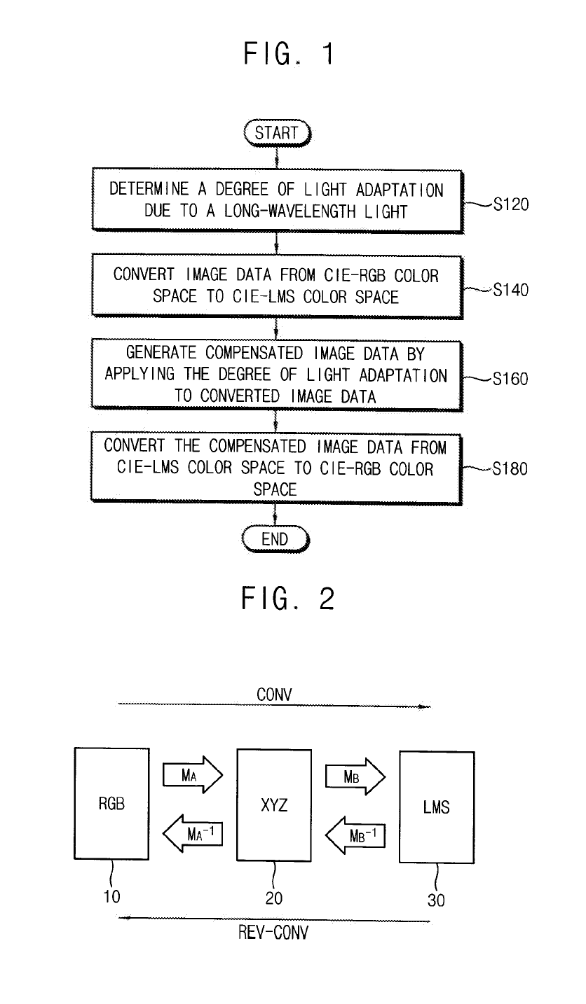

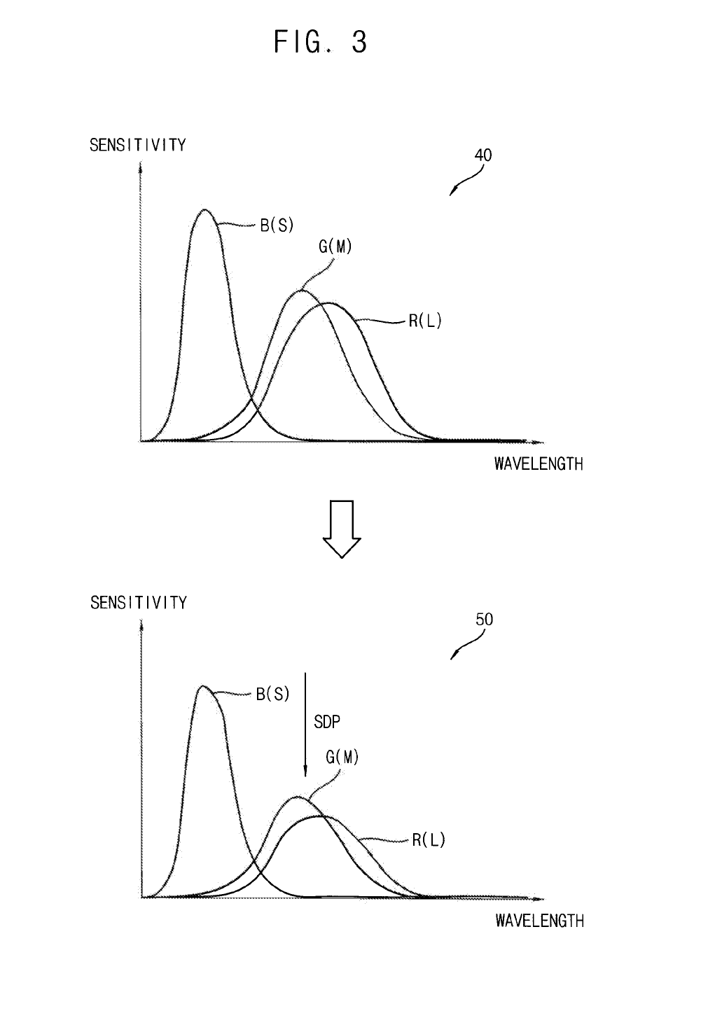

FIG. 1 is a flowchart illustrating a method of compensating an image based on light adaptation according to example embodiments. FIG. 2 is a diagram illustrating a process in which image data is compensated by the method of FIG. 1. FIG. 3 is a graph illustrating a change of a visibility curve according to an illumination environment with reference to the method of FIG. 1.

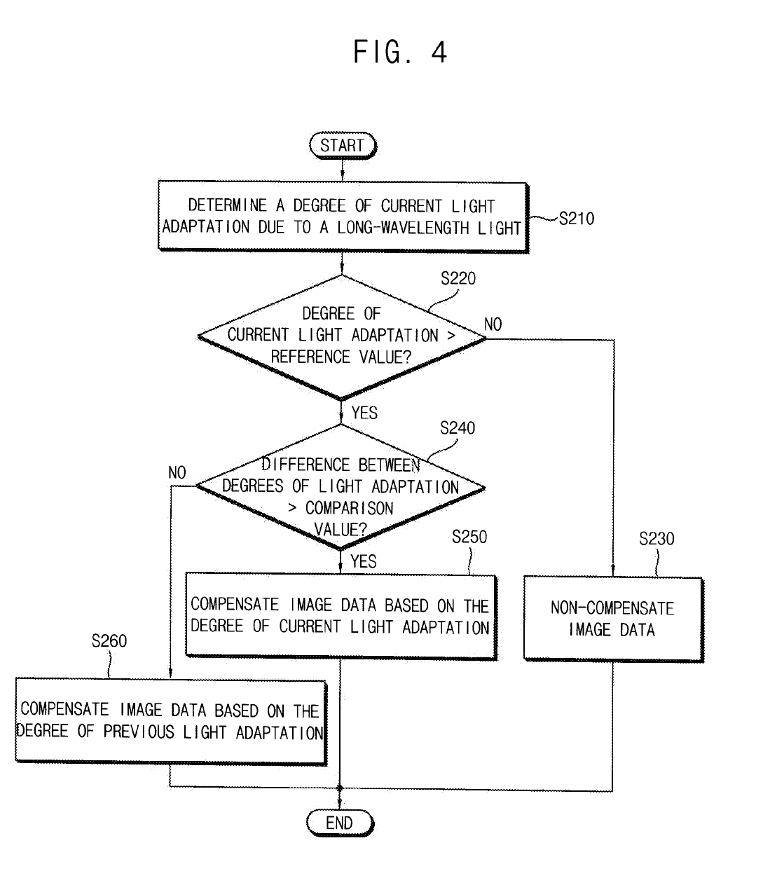

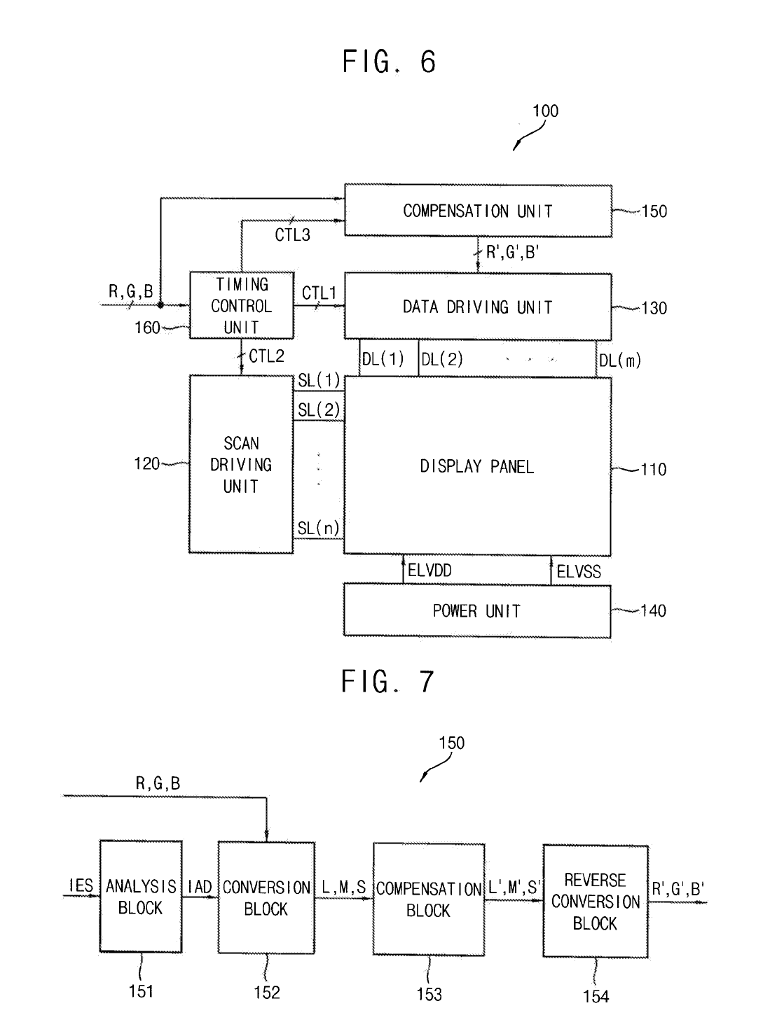

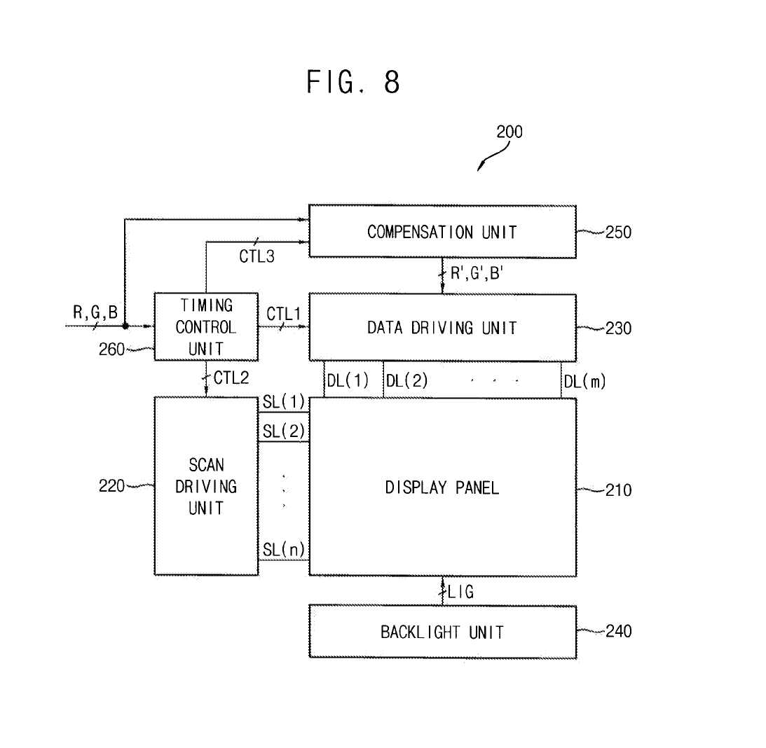

In some embodiments, the FIG. 1 procedure is implemented in a conventional programming language, such as C or C++ or another suitable programming language. The program can be stored on a computer accessible storage medium of a display device 100 (see FIG. 6) or display device 200 (see FIG. 8), for example, a memory (not shown) of the display device 100 or display device 200. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 1. The description of this paragraph applies to the embodiments shown in FIGS. 4, 11 and 14.

Referring to FIGS. 1 through 3, the method of FIG. 1 includes determining a degree of light adaptation due to a long-wavelength light by analyzing an illumination environment where a user views an image that is displayed by a display device (S120). Subsequently, the method of FIG. 1 includes converting image data (i.e., expressed in International Commission on Illumination (CIE) red-green-blue (RGB) color space or RGB color space 10) from the CIE-RGB color space 10 to CIE-long-medium-short (CIE-LMS) color space or LMS color space 30 via CIE-X-Y-Z (CIE-XYZ) color space or XYZ color space 20 (S140). Next, the method of FIG. 1 includes generating compensated image data (i.e., expressed in the CIE-LMS color space 30) by applying the degree of light adaptation due to the long-wavelength light to converted image data (i.e., expressed in the CIE-LMS color space 30) (S160). Subsequently, the method of FIG. 1 includes converting the compensated image data (i.e., expressed in the CIE-LMS color space 30) from the CIE-LMS color space 30 to the CIE-RGB color space 10 via the CIE-XYZ color space 20 (S180). That is, the method of FIG. 1 includes compensating an image using the color spaces 10, 20, and 30 that are defined by the CIE.

Generally, one important characteristic required for a display device is that a user recognizes a color as the real color of an object. To this end, typical electronic devices (i.e., typical display devices) include an algorithm related to a light-emitting characteristic of a display panel, where the light-emitting characteristic is evaluated in a darkroom (i.e., in a dark environment). However, the illumination environment where a user uses an electronic device is not fixed. Hence, the user can recognize the same color differently according to the illumination environment where the user views an image that is displayed by a display device. That is, since visibility curves related to cone cells included in eyes are independent of each other, the cone cells can be differently stimulated by the illumination environment. As a result, the user can recognize the same color differently due to light adaptation (or, illumination adaptation). In addition, a cell (e.g., referred to as suprachiasmatic nucleus) for controlling production (or, secretion) of melatonin exists in eyes as well as rod cells and cone cells for sensing a light. Here, when the suprachiasmatic nucleus is stimulated by short-wavelength light (e.g., blue color light B having a center wavelength of about 464 nm), the production of melatonin can be suppressed inside the body. Therefore, the user may not feel tired during the daytime when the short-wavelength light is relatively sufficient because the production of melatonin is suppressed inside the body. In addition, the user can feel tired (i.e., can have deep sleep) at night when the short-wavelength light is relatively insufficient because the production of melatonin is not suppressed inside the body.

However, because an image that is displayed by a display device includes red color light R, green color light G, and blue color light B, the image can cause a change of production of melatonin inside the body of a user when the user views the image. That is, the image can affect the biological clock of the user. For example, short-wavelength light (e.g., blue color light B) can suppress the production of melatonin inside the body. Thus, when a user views an image that is displayed by an electronic device (e.g., a television) at night, the user can experience sleeping disorders because the production of melatonin is suppressed inside the body of the user. For this reason, there is a recent trend to change a residential illumination environment to a light bulb color illumination environment to reduce a negative effect on the biological clock of a resident and to provide a high standard of comfort to the resident. Here, because the long-wavelength light (e.g., red color light R and green color light G) is dominant in the light bulb color illumination environment, sensitivities of L and M components located at a long-wavelength range can be reduced. As a result, an image that is displayed can look relatively blue in the light bulb color illumination environment. That is, in the light bulb color illumination environment, sensitivities of L cone cell and M cone cell are reduced by light adaptation so that the user can recognize that a color is more blue. Therefore, for the user to recognize that an image of the light bulb color illumination environment is substantially the same as an image of a normal illumination environment, it is required to reduce luminance of the short-wavelength light (e.g., blue color light B) output from an image that is displayed by the display device in the light bulb color illumination environment.

Specifically, the method of FIG. 1 can determine a degree of light adaptation due to the long-wavelength light by analyzing an illumination environment where a user views the image (S120). For example, FIG. 3 shows that a visibility curve is changed according to the illumination environment where the user views the image. As illustrated in FIG. 3, compared to a graph 40 indicating a visibility curve of a daylight color illumination environment, a sensitivity of L cone cell, a sensitivity of M cone cell, and a sensitivity of S cone cell are reduced in a graph 50 indicating a visibility curve of a light bulb color illumination environment. Generally, the red color light R is related to the L cone cell, the green color light G is related to the M cone cell, and the blue color light B is related to the S cone cell. Here, when the graph 40 indicating the visibility curve of the daylight color illumination environment is compared with the graph 50 indicating the visibility curve of the light bulb color illumination environment, the sensitivities of the L, M, and S cone cells are reduced in the light bulb color illumination environment. Particularly, the sensitivities of the L and M cone cells are much more reduced than the sensitivity of the S cone cell in the light bulb color illumination environment (i.e., indicated as SDP) by light adaptation. Thus, the blue color light B related to the S cone cell can be dominant under the same condition in the light bulb color illumination environment. As a result, the image can look relatively blue in the light bulb color illumination environment.

Subsequently, the method of FIG. 1 includes converting the image data (i.e., expressed in the CIE-RGB color space 10) from the CIE-RGB color space 10 to the CIE-LMS color space 30 via the CIE-XYZ color space 20 (S140) (i.e., indicated as CONV). As described above, when the illumination environment where the user views the image is analyzed, the degree of light adaptation due to the long-wavelength light (e.g., a degree of changes of sensitivities of L cone cell and M cone cell) can be obtained. Thus, to compensate the image data based on the degree of light adaptation due to the long-wavelength light, the image data can be converted from the CIE-RGB color space 10 to the CIE-LMS color space 30 (i.e., indicated as CONV). Here, conversion of the image data from the CIE-RGB color space 10 to the CIE-LMS color space 30 can be performed based on a color appearance model CIECAM02 of the CIE. In an example embodiment, the conversion of the image data from the CIE-RGB color space 10 to the CIE-LMS color space 30 can be performed by using [Equation 1] and [Equation 2] below.

$$[ \begin{matrix}X & \\ Y & \\ Z & \end{matrix} ] = {M}_{A} [ \begin{matrix}R & \\ G & \\ B & \end{matrix} ] , {M}_{A} = [ \begin{matrix}0.412 & 0.358 & 0.180 \\ 0.213 & 0.715 & 0.072 \\ 0.019 & 0.119 & 0.950\end{matrix} ] \qquad [ EQUATION 1 ]$$

(Here, R, G and B denote the image data expressed in the CIE-RGB color space. X, Y and Z denote the image data expressed in the CIE-XYZ color space. M_{A} denotes a CAM02-matrix used in the color appearance model.

$$[ \begin{matrix}L & \\ M & \\ S & \end{matrix} ] = {M}_{B} [ \begin{matrix}X & \\ Y & \\ Z & \end{matrix} ] , {M}_{B} = [ \begin{matrix}0.733 & 0.430 & - 0.162 \\ - 0.704 & 1.698 & 0.006 \\ 0.003 & 0.014 & 0.983\end{matrix} ] \qquad [ EQUATION 2 ]$$

(Here, X, Y and Z denote the image data expressed in the CIE-XYZ color space. L, M and S denote the image data expressed in the CIE-LMS color space. M_{B} denotes a CAT02-matrix used in the color appearance model.

Next, when the image data is expressed in the CIE-LMS color space 30, the method of FIG. 1 includes generating the compensated image data (i.e., expressed in the CIE-LMS color space 30) by applying the degree of light adaptation due to the long-wavelength light to converted image data (i.e., expressed in the CIE-LMS color space 30) (S160). In some embodiments, compensation of the image data is performed by using [Equation 3] and [Equation 4] below.

L′=((R_{Lwr}×k₁D)m+1−D)L

M′=((R_{Mwr}×k₂D)m+1−D)M

S′=((R_{Swr}×k₃D)m+1−D)S [EQUATION 3]

(Here, L, M and S denote the image data expressed in the CIE-LMS color space. L′, M′ and S′ denote compensated image data expressed in the CIE-LMS color space. R_{Lwr} denotes a variable that is proportional to a value of

$$\frac{adaptation illumination}{reference illumination}$$

with reference to L. R_{Mwr} denotes a variable that is proportional to a value of

$$\frac{adaptation illumination}{reference illumination}$$

with reference to M. R_{Swr} denotes a variable that is proportional to a value of

$$\frac{adaptation illumination}{reference illumination}$$

with reference to S. k1, k2 and k3 denote respective factors that depend on a display device. m denotes a factor that controls a degree of an effect on melatonin.)

$$D = F [ 1 - ( \frac{1}{3 \cdot 6} ) {e}^{( \frac{- ( {L}_{A} + {4}^{2} )}{0.9} )} ] \qquad [ EQUATION 4 ]$$

(Here, D denotes a light adaptation function, F denotes a light adaption coefficient. L_{A} denotes luminance of adaptation illumination.)

As shown in [Equation 3] and [Equation 4], when the degree of light adaptation due to the long-wavelength light is applied to the converted image data expressed in the CIE-LMS color space 30, the method of FIG. 1 can determine various values for variables included in [Equation 3] and [Equation 4]. Thus, an effect of the method of FIG. 1 includes minimizing the suppression of production of melatonin inside the body due to the short-wavelength light while the user does not notice the compensation of the image that is displayed by the display device. For example, k1, k2 and k3 related to color compensation can be determined within a range between 0.9 and 1.1, m related to luminance adjustment can be determined within a range between 0 and 1, and F (i.e., light adaption coefficient) can be determined within a range between 0 and 1. However, the described technology is not limited thereto. In some embodiments, the values for the variables included in [Equation 3] and [Equation 4] is repeatedly changed until the optimum image compensation is performed. In addition, to simplify an algorithm, some (e.g., L_{A}) of the variables included in [Equation 3] and [Equation 4] can be fixed.

Subsequently, when the image data is compensated based on the degree of light adaptation due to the long-wavelength light (i.e., when the compensated image data expressed in the CIE-LMS color space 30 are generated), the method of FIG. 1 includes converting the compensated image data (i.e., expressed in the CIE-LMS color space 30) from the CIE-LMS color space 30 to the CIE-RGB color space 10 via the CIE-XYZ color space 20 (S180) (i.e., indicated as REV-CONV). This is because the display device displays an image based on the image data (i.e., converted compensated image data) expressed in the CIE-RGB color space 10. Here, the conversion of the compensated image data from the CIE-LMS color space 30 to the CIE-RGB color space 10 via the CIE-XYZ color space 20 can be performed based on the color appearance model CIECAM02 of the CIE. In some embodiments, the conversion of the compensated image data from the CIE-LMS color space 30 to the CIE-RGB color space 10 via the CIE-XYZ color space 20 is performed by using [Equation 5] and [Equation 6] below.

$$[ \begin{matrix}{X}^{′} & \\ {Y}^{′} & \\ {Z}^{′} & \end{matrix} ] = {M}_{B}^{- 1} [ \begin{matrix}{L}^{′} & \\ {M}^{′} & \\ {S}^{′} & \end{matrix} ] \qquad [ EQUATION 5 ]$$

(Here, L′, M′ and S′ denote compensated image data expressed in the CIE-LMS color space. X′, Y′ and Z′ denote compensated image data expressed in the CIE-XYZ color space. M_{B}⁻¹ denotes an inverse matrix of the CAT02-matrix used in the color appearance model.

$$[ \begin{matrix}{R}^{′} & \\ {G}^{′} & \\ {B}^{′} & \end{matrix} ] = {M}_{A}^{- 1} [ \begin{matrix}{X}^{′} & \\ {Y}^{′} & \\ {Z}^{′} & \end{matrix} ] \qquad [ EQUATION 6 ]$$

(Here, X′, Y′ and Z′ denote the compensated image data expressed in the CIE-XYZ color space. R′, G′ and B′ denote the compensated image data expressed in the CIE-RGB color space. M_{A}⁻¹ denotes an inverse matrix of the CAM02-matrix used in the color appearance model.

Next, the method of FIG. 1 can display an image based on the image data (i.e., converted compensated image data) expressed in the CIE-RGB color space 10. That is, the method of FIG. 1 can compensate the image using the color spaces 10, 20, and 30 that are defined by the CIE. In brief, the method of FIG. 1 can compensate the image data based on the degree of light adaptation due to the long-wavelength light to decrease luminance of the short-wavelength light output from the image that is displayed by the display device. Thus, the method of FIG. 1 can minimize (or, reduce) suppression of production of melatonin inside the body of the user while the user does not notice compensation of the image that is displayed by the display device. As a result, sleeping disorders due to suppression of production of melatonin can be prevented even when the user views the image that is displayed by the display device at night. That is, the method of FIG. 1 can reduce a bad effect on biological clock of the user (e.g., sleeping disorders) when the user views the image that is displayed by the display device. In addition, the method of FIG. 1 can express natural color by decreasing luminance of the short-wavelength light based on light adaptation due to an illumination environment (e.g., including an indoor illumination environment and an outdoor illumination environment).

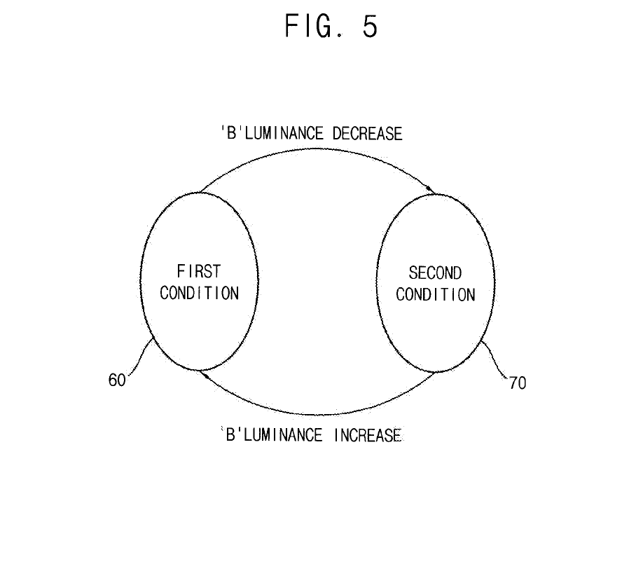

FIG. 4 is a diagram illustrating an example in which a degree of light adaptation due to a long-wavelength light is applied to converted image data by the method of FIG. 1. FIG. 5 is a diagram illustrating an effect of the image data that is compensated by the method of FIGS. 1 and 4.

Referring to FIGS. 4 and 5, the method of FIG. 4 includes determining a degree of current light adaptation due to a long-wavelength light by analyzing an illumination environment where a user views an image that is displayed by a display device (S210). The method further includes checking whether the degree of current light adaptation due to the long-wavelength light is greater than a predetermined reference value (S220). Here, when the degree of current light adaptation is less than the predetermined reference value, the method of FIG. 4 does not include compensating the image data for implementing the image (S230). On the other hand, when the degree of current light adaptation is greater than the predetermined reference value, the method of FIG. 4 includes checking whether a difference between the degree of current light adaptation and a degree of the previous light adaptation is greater than a predetermined comparison value (S240). Here, when the difference between the degree of current light adaptation and the degree of the previous light adaptation is greater than the predetermined comparison value, the method of FIG. 4 includes compensating the image data by applying the degree of current light adaptation to the converted image data (S250). On the other hand, when the difference between the degree of current light adaptation and the degree of the previous light adaptation is less than the predetermined comparison value, the method of FIG. 4 includes compensating the image data by applying the degree of previous light adaptation to the converted image data (S260).

As described above, when the method of FIG. 4 compensates the image data based on the degree of light adaptation, the method of FIG. 4 can compensate the image data only when the degree of the current light adaptation is greater than the predetermined reference value, and can change the degree of compensation only when the difference between the degree of current light adaptation and the degree of the previous light adaptation is greater than the predetermined comparison value. That is, when the image compensation is performed whenever a minor change of the illumination environment occurs, the user can notice the image compensation because the image compensation is frequently performed. In addition, an effect of the image compensation for reflecting the minor change of the illumination environment can be less effective. For this reason, the method of FIG. 4 can compensate the image data only when the degree of current light adaptation is greater than the predetermined reference value, and can change the degree of the compensation only when the difference between the degree of the current light adaptation and the degree of the previous light adaptation is greater than the predetermined comparison value. However, the described technology is not limited thereto.

When the image data is compensated based on the degree of light adaptation due to the long-wavelength light by the methods of FIGS. 1 and 4, the negative effect on the biological clock of the user viewing the image can be prevented (or, reduced). In addition, unnecessary power consumption and pixel degradation can be prevented (or, reduced) when the display device is an organic light-emitting diode (OLED) display. For example, the production of melatonin can increase inside the body as luminance of the short-wavelength light (e.g., blue color light B) output from the image that is displayed by the display device decreases. On the other hand, the production of melatonin can decrease as luminance of the short-wavelength light (e.g., the blue color light B) output from the image increases. In some embodiments, as illustrated in FIG. 5, the methods of FIGS. 1 and 4 can perform the image compensation under a first condition 60 in which luminance of the blue color light B is required to be high or under a second condition 70 in which the luminance of the blue color light B is required to be low. Under the first condition 60, the production of melatonin can be reduced because the luminance of the blue color light B is relatively high. For example, the first condition 60 can correspond to daytime. Under the second condition 70, the production of melatonin can be increased because the luminance of the blue color light B is relatively low. For example, the second condition 70 can correspond to night. In some embodiments, because the user needs to be active during the daytime (i.e., suppression of production of melatonin is required), the methods of FIGS. 1 and 4 do not decrease luminance of the blue color light B when the light adaptation due to the light bulb color illumination environment occurs as the user stays indoors. In some embodiments, because the user needs to fall asleep at night (i.e., production of melatonin is required), the methods of FIGS. 1 and 4 can intentionally decrease the luminance of the blue color light B even when the user does not stay in the light bulb color illumination environment.

FIG. 6 is a block diagram illustrating a display device according to example embodiments. FIG. 7 is a block diagram illustrating an example of a compensation unit included in the display device of FIG. 6.

Referring to FIGS. 6 and 7, the display device 100 can be an OLED display. Specifically, the display device 100 includes a display panel 110, a scan driving unit or scan driver 120, a data driving unit or data driver 130, a power unit 140, a compensation unit 150, and a timing control unit or timing controller 160. In some embodiments, as illustrated in FIG. 6, the compensation unit 150 is external to the timing control unit 160 and the data driving unit 130. In other embodiments, the compensation unit 150 is included in the timing control unit 160 or in the data driving unit 130.

The display panel 110 includes a plurality of pixels. The display panel 110 is coupled to the scan driving unit 120 via a plurality of scan lines SL(1) through SL(n), and is coupled to the data driving unit 130 via a plurality of data lines DL(1) through DL(m). Here, the pixels are arranged at locations corresponding to crossing points of the scan lines SL(1) through SL(n) and the data lines DL(1) through DL(m). Thus, the display panel 110 includes n*m pixels. The scan driving unit 120 can provide a scan signal to the display panel 110 via the scan lines SL(1) through SL(n). The data driving unit 130 can provide a data signal to the display panel 110 via the data lines DL(1) through DL(m). The power unit 140 can provide a high power voltage ELVDD and a low power voltage ELVSS to the display panel 110. The compensation unit 150 can generate the compensated image data R′, G′, and B′ by compensating the image data R, G, and B corresponding to the data signal based on a degree IAD of light adaptation due to a long-wavelength light (i.e., green color light and red color light) so as to decrease luminance of a short-wavelength light (i.e., blue color light) output from an image that is displayed on the display panel 110. The timing control unit 160 can control the scan driving unit 120, the data driving unit 130, and the compensation unit 150 based on first through third control signals CTL1, CTL2, and CTL3. In some embodiments, the display device 100 can further include an emission control unit (not shown) that outputs an emission control signal for controlling light-emitting operations of the pixels included in the display panel 110.

As illustrated in FIG. 7, the compensation unit 150 includes an analysis block 151, a conversion block 152, a compensation block 153, and a reverse conversion block 154. Specifically, the analysis block 151 can determine the degree IAD by analyzing an illumination environment IES where the user views the image. For example, the short-wavelength light can be the blue color light, and the long-wavelength light can be the red color light and the green color light. The conversion block 152 can generate the image data L, M, and S by converting the image data R, G, and B from the CIE-RGB color space to the CIE-LMS color space via the CIE-XYZ color space. The compensation block 153 can generate the compensated image data L′, M′, and S′ by applying the degree IAD o to the converted image data L, M, and S. The reverse conversion block 154 can generate compensated image data R′, G′, and B′ by converting the compensated image data L′, M′, and S′ from the CIE-LMS color space to the CIE-RGB color space via the CIE-XYZ color space. Thus, the data signal transferred from the data driving unit 130 to the display panel 110 can be compensated based on the degree IAD by the compensation unit 150. However, the described technology is not limited thereto.

As described above, the display device 100 can determine the degree IAD by analyzing the illumination environment IES, can convert the image data R, G, and B from the CIE-RGB color space to the CIE-LMS color space via the CIE-XYZ color space, can generate the compensated image data L′, M′, and S′ by applying the degree IAD to the converted image data L, M, and S, and can convert the compensated image data L′, M′, and S′ from the CIE-LMS color space to the CIE-RGB color space via the CIE-XYZ color space. In this way, the display device 100 can display the image on the display panel 110 based on the compensated image data R′, G′, and B′. Thus, the display device 100 can minimize (or, reduce) suppression of the production of melatonin while the user does not notice the compensation of the image that is displayed by the display device 100. As a result, the negative effect on the biological clock of the user (e.g., sleeping disorders) can be reduced when the user views the image. In addition, as illustrated in FIG. 6, when the display device 100 is an OLED display, a pixel that outputs the blue color light can be more easily degraded than a pixel that outputs the red color light or the green color light. For this reason, the lifespan of the OLED display is limited by the pixel that outputs the blue color light. Therefore, the display device 100 can reduce unnecessary power consumption and pixel degradation by decreasing luminance of the short-wavelength light (i.e., blue color light).

FIG. 8 is a block diagram illustrating a display device according to example embodiments.

Referring to FIG. 8, the display device 200 can be a liquid crystal display (LCD). Specifically, the display device 200 includes a display panel 210, a scan driving unit or scan driver 220, a data driving unit or data driver 230, a backlight unit 240, a compensation unit 250, and a timing control unit or timing controller 260. In some embodiments, as illustrated in FIG. 8, the compensation unit 250 is external to the timing control unit 260 and the data driving unit 230. In some embodiments, the compensation unit 250 is included in the timing control unit 260 or in the data driving unit 230.

The display panel 210 includes a plurality of pixels. The display panel 210 are coupled to the scan driving unit 220 via a plurality of scan lines SL(1) through SL(n), and are coupled to the data driving unit 230 via a plurality of data lines DL(1) through DL(m). Here, the pixels can be arranged at locations corresponding to crossing points of the scan lines SL(1) through SL(n) and the data lines DL(1) through DL(m). Thus, the display panel 210 includes n*m pixels. The scan driving unit 220 can provide a scan signal to the display panel 210 via the scan lines SL(1) through SL(n). The data driving unit 230 can provide a data signal to the display panel 210 via the data lines DL(1) through DL(m). The backlight unit 240 can provide light LIG to the display panel 210. The compensation unit 250 can generate compensated image data R′, G′, and B′ by compensating image data R, G, and B corresponding to the data signal based on a degree of light adaptation due to a long-wavelength light (i.e., green color light and red color light) so as to decrease luminance of a short-wavelength light (i.e., blue color light) output from an image that is displayed on the display panel 210. For this operation, the compensation unit 250 can include an analysis block, a conversion block, a compensation block, and a reverse conversion block. Because the analysis block, the conversion block, the compensation block, and the reverse conversion block are described with reference to FIG. 7, duplicated description will not be repeated. The timing control unit 260 can control the scan driving unit 220, the data driving unit 230, and the compensation unit 250 based on first through third control signals CTL1, CTL2, and CTL3.

As described above, the display device 200 can determine the degree of light adaptation due to the long-wavelength light by analyzing an illumination environment where a user views the image that is displayed by the display device 200, can convert image data R, G, and B from the CIE-RGB color space to the CIE-LMS color space via the CIE-XYZ color space, can generate compensated image data L′, M′, and S′ by applying the degree of light adaptation to converted image data L, M, and S, and can convert the compensated image data L′, M′, and S′ from the CIE-LMS color space to the CIE-RGB color space via the CIE-XYZ color space. In this way, the display device 200 can display the image on the display panel 210 based on the compensated image data R′, G′, and B′. Thus, the display device 200 can minimize (or, reduce) suppression of production of melatonin inside the body of the user while the user does not notice compensation of the image that is displayed by the display device 200. As a result, negative effect on the biological clock of the user (e.g., sleeping disorders) can be reduced when the user views the image that is displayed by the display device 200.

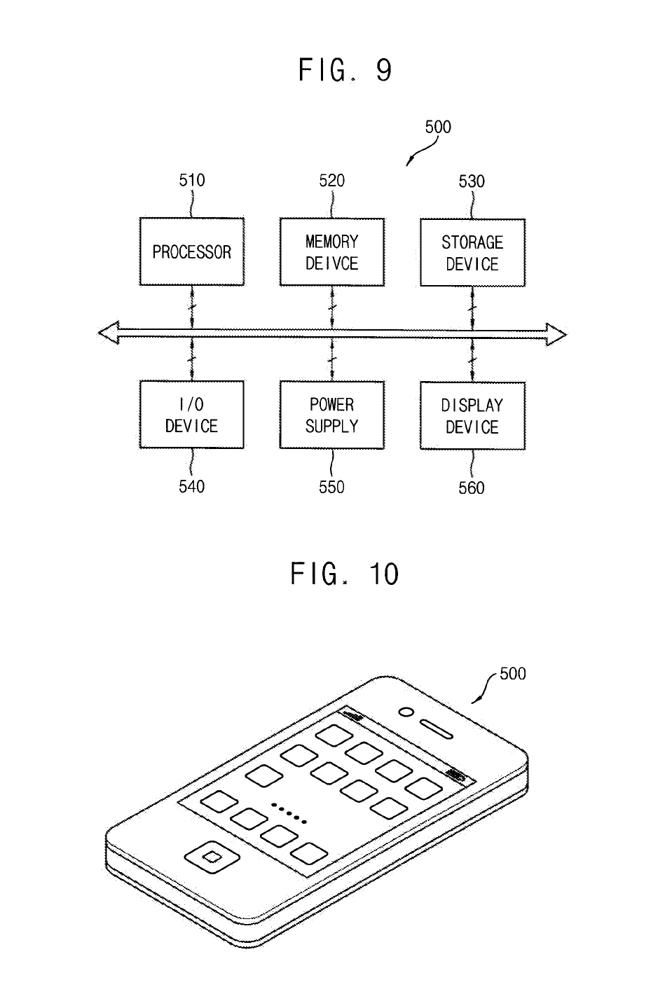

FIG. 9 is a block diagram illustrating an electronic device according to example embodiments. FIG. 10 is a diagram illustrating an example in which the electronic device of FIG. 9 is a smartphone.

Referring to FIGS. 9 and 10, the electronic device 500 includes a processor 510, a memory device 520, a storage device 530, an input/output (I/O) device 540, a power supply 550, and a display device 560. Here, the display device 560 can be the OLED display 100 of FIG. 6 or the LCD device 200 of FIG. 8. In addition, the electronic device 500 further includes a plurality of ports for communicating a video card, a sound card, a memory card, a universal serial bus (USB) device, other electronic devices, etc. In some embodiments, as illustrated in FIG. 10, the electronic device 500 is implemented as a smartphone 500. However, the implementation of the electronic device 500 is not limited thereto. For example, the electronic device 500 can be implemented as a digital television (TV), a 3D TV, a smart TV, a computer, a laptop, a tablet personal computer (PC), a cellular phone, a smartphone, a smart pad, a personal digital assistant (PDA), a portable multimedia player (PMP), a digital camera, etc.

The processor 510 can perform various computing functions. The processor 510 can be a microprocessor, a central processing unit (CPU), etc. The processor 510 can be coupled to other components via an address bus, a control bus, a data bus, etc. Further, the processor 510 can be coupled to an extended bus such as a peripheral component interconnection (PCI) bus. The memory device 520 can store data for operations of the electronic device 500. For example, the memory device 520 can include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile dynamic random access memory (mobile DRAM) device, etc. The storage device 530 can be a solid state drive (SSD) device, a hard disk drive (HDD) device, a CD-ROM device, etc. The I/O device 540 can be an input device such as a keyboard, a keypad, a touchpad, a mouse, a touch-screen, etc., and an output device such as a printer, a speaker, etc. In some embodiments, the display device 560 can be included in the I/O device 540. The power supply 550 can provide a power for operating the electronic device 500.

The display device 560 can communicate with other components via the buses or other communication links. As described above, the display device 560 can determine a degree of light adaptation due to a long-wavelength light by analyzing an illumination environment where a user views an image that is displayed by the display device 560, can convert the image data from the CIE-RGB color space to the CIE-LMS color space via the CIE-XYZ color space, can generate the compensated image data by applying the degree of light adaptation due to the long-wavelength light to the converted image data in the CIE-LMS color space, and can convert the compensated image data from the CIE-LMS color space to the CIE-RGB color space via the CIE-XYZ color space. For this operation, the display device 560 can include a compensation unit that can compensate image data based on the degree of light adaptation due to a long-wavelength light (i.e., green color light and red color light) so as to decrease luminance of a short-wavelength light (i.e., blue color light) output from an image that is displayed by the display device 560. Here, the compensation unit can include an analysis block, a conversion block, a compensation block, and a reverse conversion block. The analysis block can determine the degree of light adaptation due to the long-wavelength light by analyzing the illumination environment. The conversion block can convert the image data from the CIE-RGB color space to the CIE-LMS color space via the CIE-XYZ color space. The compensation block can generate the compensated image data by applying the degree of light adaptation due to the long-wavelength light to the converted image data. The reverse conversion block can generate compensated image data by converting the compensated image data from the CIE-LMS color space to the CIE-RGB color space via the CIE-XYZ color space. Because the analysis block, the conversion block, the compensation block, and the reverse conversion block are described with reference to FIG. 7, duplicated description will not be repeated.

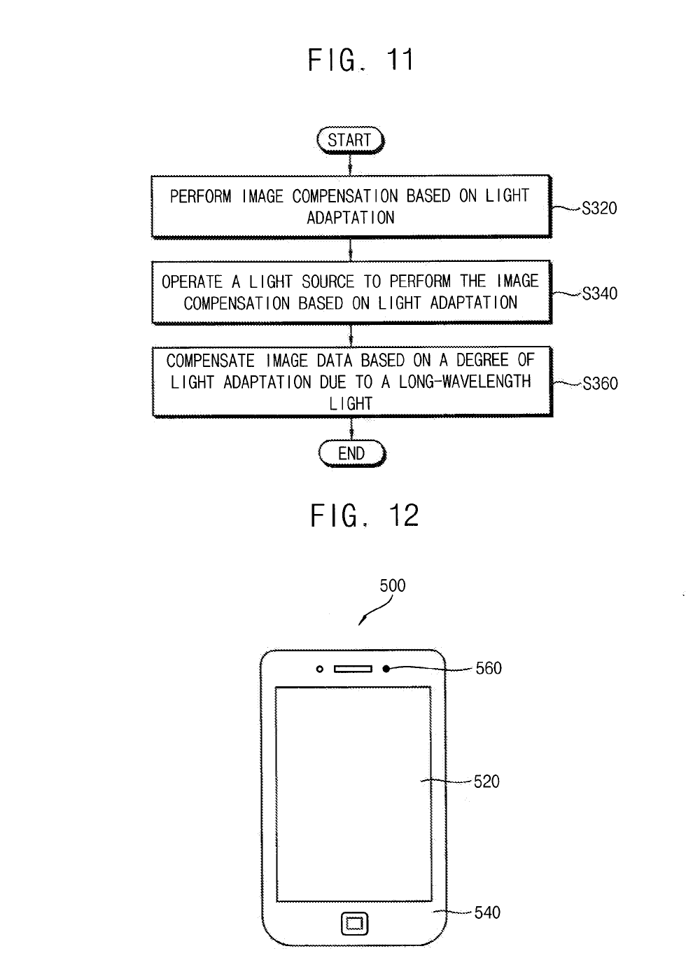

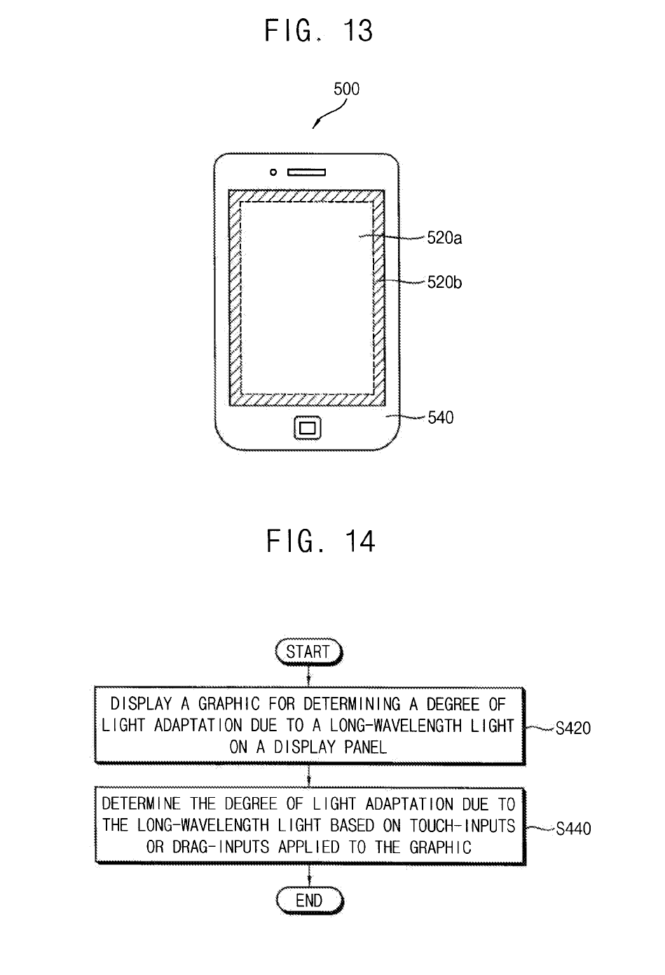

FIG. 11 is a flowchart illustrating a process in which image compensation based on light adaptation is performed by the electronic device of FIG. 9. FIG. 12 is a diagram illustrating an example of a light source included in the electronic device of FIG. 9 for performing image compensation based on light adaptation. FIG. 13 is a diagram illustrating another example of a light source included in the electronic device of FIG. 9 for performing image compensation based on light adaptation.

Referring to FIGS. 11 through 13, the electronic device 500 can perform image compensation based on light adaptation. Specifically, the electronic device 500 can perform the image compensation based on light adaptation (S320). In some embodiments, the electronic device 500 can perform the image compensation based on light adaptation in response to a user command. For example, when a user provides the electronic device 500 with a user command for minimizing suppression of production of melatonin inside the body of the user or for reducing unnecessary power consumption and pixel degradation of a display device included in the electronic device 500, the electronic device 500 can perform the image compensation based on light adaptation. In some embodiments, the electronic device 500 can perform the image compensation based on light adaptation by analyzing an illumination environment. For example, when it is required to minimize the suppression of the production of melatonin inside the body of the user or to reduce unnecessary power consumption and pixel degradation of the display device included in the electronic device 500, the electronic device 500 can perform the image compensation based on light adaptation. However, a method of performing the image compensation based on light adaptation is not limited thereto.

Subsequently, the electronic device 500 can operate a light source included in the electronic device 500 to perform the image compensation based on light adaptation (S340). In some embodiment, as illustrated in FIG. 12, the light source included in the electronic device 500 is an illumination device 560 that is located outside a display panel 520. That is, the illumination device 560 can be located on a body 540 of the electronic device 500. In this case, the illumination device 560 can illuminate a long-wavelength light on a user when the user views an image. Although it is illustrated in FIG. 12 that one illumination device 560 is located on the body 540, a plurality of illumination devices 560 can be located on the body 540 (e.g., along the bezel of the electronic device 500). In some embodiments, as illustrated in FIG. 13, the light source included in the electronic device 500 is a region 520b of the display panel 520. In this case, the region 520b illuminates a long-wavelength light on a user when the user views the image on another region 520a of the display panel 520. For example, when the electronic device 500 does not perform the image compensation, an image can be displayed on both regions 520a and 520b of the display panel 520. On the other hand, when the electronic device 500 performs the image compensation based on light adaptation, an image can be displayed on the region 520a, and the long-wavelength light can be output from the region 520b. Although it is illustrated in FIG. 13 that the region 520b is an outer region of the display panel 520 and the region 520a is an inner region of the display panel 520, the regions 520a and 520b can be determined in various ways according to requirements of the electronic device 500.

Next, the electronic device 500 can compensate image data based on a degree of light adaptation due to the long-wavelength light output from the light source to decrease luminance of the short-wavelength light output from an image that is displayed on the display panel 520 (S360). Thus, the electronic device 500 can minimize (or, reduce) suppression of production of melatonin inside the body of the user while the user does not notice compensation of the image that is displayed on the display panel 520. As described above, the electronic device 500 can intentionally create an illumination environment for performing the image compensation based on light adaptation. The electronic device 500 can then perform the image compensation based on light adaptation. Thus, the electronic device 500 can reduce negative effect on the biological clock of the user (e.g., sleeping disorders) when the user views the image that is displayed by the electronic device 500, and can reduce unnecessary power consumption and pixel degradation when the electronic device 500 includes an OLED display. Although it is described above that the electronic device 500 is implemented as a mobile device such as a smartphone, the electronic device 500 can be implemented as a non-mobile device such as a television, a personal computer, etc. Although it is described above that the light source is included in the electronic device 500, the light source can be external to the electronic device 500.

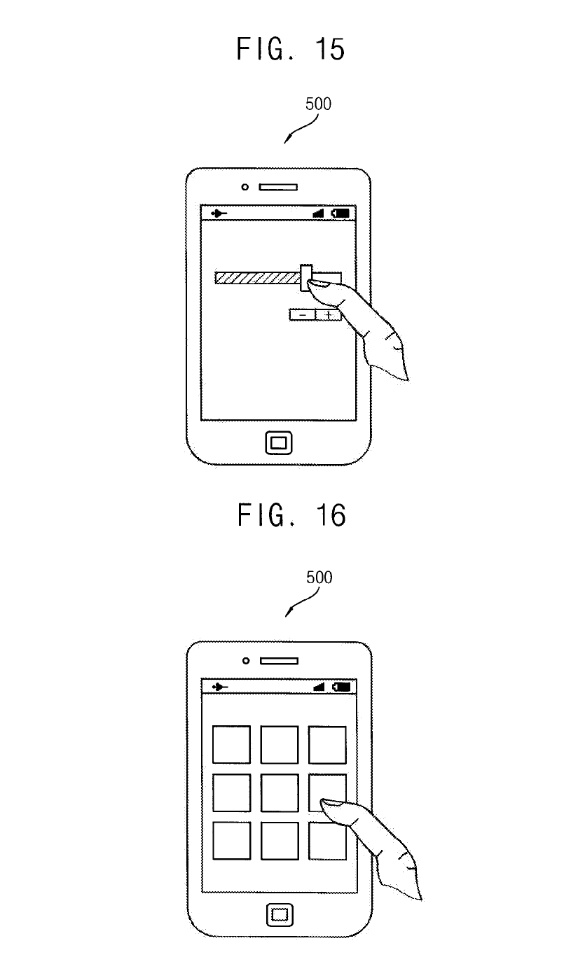

FIG. 14 is a flowchart illustrating a process in which a degree of light adaptation due to a long-wavelength light is determined in the electronic device of FIG. 9. FIG. 15 is a diagram illustrating an example in which a user determines a degree of light adaptation due to a long-wavelength light in the electronic device of FIG. 9. FIG. 16 is a diagram illustrating another example in which a user determines a degree of light adaptation due to a long-wavelength light in the electronic device of FIG. 9.

Referring to FIGS. 14 through 16, the electronic device 500 can determine a degree of light adaptation due to a long-wavelength light (i.e., a degree of image compensation based on light adaptation). Here, the electronic device 500 can allow a user to determine the degree of light adaptation due to the long-wavelength light by touching or dragging a graphic displayed on a display panel based on a graphic user interface. Specifically, the electronic device 500 can display a graphic for determining the degree of light adaptation due to the long-wavelength light on the display panel (S420). In some embodiments, as illustrated in FIG. 15, the graphic is a bar-shaped graphic. In some embodiments, as illustrated in FIG. 16, the graphic is an icon-shaped graphic. Subsequently, the electronic device 500 can determine the degree of light adaptation due to the long-wavelength light based on touch-inputs or drag-inputs applied to the graphic by the user (S440). In some embodiments, as illustrated in FIG. 15, when the graphic is the bar-shaped graphic, the user determines the degree of light adaptation by dragging (or, moving) the bar-shaped graphic from side to side. For example, as the user drags the bar-shaped graphic to the left side, the degree of light adaptation can be decreased. On the other hand, as the user drags the bar-shaped graphic to the right side, the degree of light adaptation can be increased. In some embodiments, as illustrated in FIG. 16, when the graphic for is the icon-shaped graphic, the user can determine the degree of light adaptation by touching the icon-shaped graphic from side to side. For example, respective icons can indicate respective degrees of light adaptation. Thus, when the user touches a specific icon among the icons, a specific degree of light adaptation due to the long-wavelength light (i.e., indicated by the specific icon) can be determined. In brief, the electronic device 500 can provide the user with a function of determining the degree of light adaptation due to the long-wavelength light.

The foregoing is illustrative of the inventive technology and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of compensating an image to be displayed by a display device based on light adaptation, the method comprising:
determining a degree of light adaptation based on an amount of long-wavelength light in an illumination environment where the image is displayed;
converting image data in International Commission on Illumination (CIE) red-green-blue (RGB) color space to image data in CIE long-medium-short (LMS) color space for implementing the image via CIE-XYZ color space;
applying the degree of light adaptation to the converted image data in the CIE-LMS color space so as to generate compensated image data; and
converting the compensated image data in the CIE-LMS color space to image data to be displayed in the CIE-RGB color space via the CIE-XYZ color space.

2. The method of claim 1, wherein the applying is performed when the degree of light adaptation is greater than a predetermined reference value.

3. The method of claim 2, wherein, when the difference between degrees of the current light adaptation and the previous light adaptation based on the amount of long-wavelength light in the environment is less than a predetermined comparison value, the degree of the previous light adaptation is applied to the converted image data.

4. The method of claim 1, wherein the luminance of a short-wavelength light output from the image decreases as the degree of light adaptation increases.

5. The method of claim 4, wherein production of melatonin increases inside the body of the user as the luminance of the short-wavelength light decreases.

6. The method of claim 4, wherein, when the display device is an organic light-emitting diode (OLED) display, the lifespan of the display device increases as the luminance of the short-wavelength light decreases.

7. The method of claim 4, wherein the short-wavelength light includes blue color light, and wherein the long-wavelength light includes red color light and green color light.

8. A display device comprising:
a display panel including a plurality of pixels;
a scan driver configured to provide at least one scan signal to the display panel;
a data driver configured to provide at least one data signal to the display panel;
a compensation unit configured to decrease luminance of a short-wavelength light output from an image displayed on the display panel based on image data corresponding to the data signal and a degree of light adaptation based on an amount of long-wavelength light in the environment; and
a timing controller configured to control the scan driver, the data driver, and the compensation unit.

9. The device of claim 8, wherein the compensation unit is located outside the timing controller and the data driver.

10. The device of claim 8, wherein the timing controller or the data driver includes the compensation unit.

11. The device of claim 8, further comprising a power unit configured to provide high and low power voltages to the display panel, wherein the display device is an organic light-emitting diode (OLED) display.

12. The device of claim 8, further comprising a backlight unit configured to provide light to the display panel, wherein the display device is a liquid crystal display (LCD).

13. The device of claim 8, wherein the compensation unit includes:
an analysis block configured to determine the degree of light adaptation in an illumination environment where a user views the image;
a conversion block configured to convert the image data in International Commission on Illumination (CIE) red-green-blue (RGB) color space to converted image data in CIE long-medium-short (LMS) color space via CIE-XYZ color space;
a compensation block configured to apply the degree of light adaptation to the converted image data so as to generate compensated image data; and
a reverse conversion block configured to convert the compensated image data in the CIE-LMS color space to displayed image data in the CIE-RGB color space via the CIE-XYZ color space.

14. The device of claim 13, wherein the compensation unit is configured to generate the displayed image data when the degree of light adaptation is greater than a predetermined reference value.

15. The device of claim 14, wherein, when the difference between degrees of the current light adaptation and the previous light adaptation based on the long-wavelength light in the environment is less than a predetermined comparison value, the compensation unit is configured to apply the degree of the previous light adaptation to the converted image data.

16. The device of claim 13, wherein the compensation unit is configured to decrease the luminance of the short-wavelength light output from the image when the degree of light adaptation increases.

17. The device of claim 16, wherein the short-wavelength light includes blue color light, and wherein the long-wavelength light includes red color light and green color light.

18. An electronic device comprising:
a display device;
a memory device electrically connected to the display device; and
a processor configured to control the display device and the memory device, wherein the display device includes:
a display panel including a plurality of pixels;
a data driver configured to provide at least one data signal to the display panel; and
a compensation unit configured to decrease luminance of a short-wavelength light output from an image displayed on the display panel based on image data corresponding to the data signal and a degree of light adaptation based on an amount of long-wavelength light in the environment.

19. The electronic device of claim 18, wherein the compensation unit includes:
an analysis block configured to determine the degree of light adaptation in an illumination environment where the image is displayed;
a conversion block configured to convert the image data in International Commission on Illumination (CIE) red-green-blue (RGB) color space to converted image data in CIE long-medium-short (LMS) color space via CIE-XYZ color space;
a compensation block configured to apply the degree of light adaptation to the converted image data so as to generate compensated image data; and
a reverse conversion block configured to convert the compensated image data in the CIE-LMS color space to displayed image data in the CIE-RGB color space via the CIE-XYZ color space.

20. The electronic device of claim 19, wherein the degree of light adaptation corresponds to touching or dragging a graphic displayed on the display panel based on a graphical user interface.
